(19) United States
(12) Patent Application Publication
(10) Pub. No.: US 2014/0361752 A1
(43) Pub. Date: Dec. 11, 2014

(54) BATTERY CHARGING METHOD AND APPARATUS

(71) Applicant: International Battery Corporation, Camarillo, CA (US)

(72) Inventor: Bill William Brecht, Long Beach, CA (US)

(73) Assignee: International Battery Corporation, Camarillo, CA (US)

(21) Appl. No.: 13/913,352

(22) Filed: Jun. 7, 2013

(51) Int. Cl. H02J 7/00

(52) U.S. Cl. CPC H02J 7/0052
USPC 320/149; 320/161

(57) ABSTRACT

Methods for charging batteries comprises applying a charging current to the battery, monitoring the voltages of the positive and negative electrodes during the step of applying the charging current, and determining a point during the process of applying the charging current where the negative electrode is fully charged. Monitoring comprises determining the total battery voltage from the combined voltages of the battery positive and negative electrodes. The slopes along the total battery voltage are measured to obtain a trend line of the change in the slope of the total battery voltage during charging. The trend line is monitored against a logarithm of the applied charging current to determine a point where the negative electrodes are in a state of full charge, at which point the positive electrodes are also fully charged. The charging operation is terminated once such state of fully charge has been determined.

### FIELD

A battery charging method and apparatus for implementing the same is disclosed herein and, more specifically, a battery charging method and apparatus designed to optimize the charge state of a battery in a manner that does not negatively impact the effective service life of the battery.

### BACKGROUND

Batteries are commonly used to power a number of remotely-powered electrical devices. Such batteries can either be of the rechargeable or non-rechargeable/disposable variety. Rechargeable batteries are engineered to be repeatedly placed into service in a charged state, and removed from service and recharged when in a depleted state. A category of well-known rechargeable batteries include flooded electrolyte batteries, such as lead-acid batteries that can be used for service in vehicle and other types of applications.

Such rechargeable, e.g., lead-acid, batteries are conventionally recharged by applying a charging current to the battery for a determined amount of time. The length of the recharge period can simply be a function of time independent on the actual condition of the battery, e.g., where a battery charger is configured having a timer that is set for a charging time. Alternatively, the amount of time can be determined by a more sophisticated charging system that actually monitors a parameter of the battery as it is being charged, and that is configured to terminate the charging current once the defined parameter is met. Conventionally, this can be when a certain level of outgassing is detected (at which point the electrolyte starts to bubble and a detectable change is detected). Another way of determining the charger shut off point is by measuring the specific gravity of the acid, and turning off the charging current once a specific gravity consistent with a desired restored acid concentration is detected.

A shortcoming of such conventional battery charging approaches is they are not desired to provide an optimum level of battery charge and/or they charge the battery in a manner that causes damage to the battery. For example, certain levels of outgassing or electrolyte boiling during the charging process is not desired as it is known to damage or destroy the active materials on the electrodes. Further, none of the conventional battery charging approaches provide a fully battery charge, meaning that such charging methods do not result in a battery both the positive and negative electrodes in a full state.

It is, therefore, desired that a method for charging a battery and an apparatus for implementing the same be developed that enables one to charge a battery in a manner that both provides an optimum state of charge while also protecting the battery from unwanted damage thereto during the battery charging process.

### SUMMARY

Methods for charging rechargeable batteries comprising a positive and negative electrode are disclosed herein. In an example, such method comprises applying a charging current to the battery, monitoring the voltages of the positive and negative electrodes during the step of applying the charging current, and determining a point during the process of applying the charging current where the negative electrode is fully charged.

In an example, the step of monitoring comprises determining the total battery voltage from the combined voltages of the battery positive and negative electrodes. The total battery voltage is taken by adding the negative voltage to the positive voltage. The slopes along the total battery voltage are measured to obtain a trend line of the change in the slope of the total battery voltage during charging. In an example, the trend line is monitored against a logarithm of the applied charging current.

The trend line comprises a first straight section that relates to a constant slope of the positive electrode voltage when it is in a state of being charged, a second angled section extending from the first section that relates to a change in slope between the positive electrode voltage when it is in a state of being charged and the combined positive and negative voltages when each are in a state of being charged, and a third straight section that relates to a constant slope of the combined positive and negative electrode voltages when each is in a state of charge.

In an example, the point where the negative electrode is approaching full charge occurs on the trend line where the slope of the trend line goes being angled to being straight, e.g., at the intersection of the trend line second and third sections. At this point, the positive electrode is also fully charged. In an example, the charging operation is terminated at a point after the intersection of the trend line second and third sections and along the third section where the negative electrode is fully charged.

Battery charging methods and algorithms as disclosed herein provide a manner of charging a battery that depends on how the battery itself responds to a charging current, by monitoring the total battery voltage and by trend line analysis, thereby providing an optimum state of charge while also protecting the battery from unwanted damage thereto that could otherwise result from unwanted overcharge. Charging batteries according to such charging methods and algorithms can improve the service life of rechargeable valve regulated lead acid batteries, e.g., by doubling the service life.

### BRIEF DESCRIPTION OF THE DRAWINGS

These and other features and advantages of battery charging methods and devices for implementing the same as disclosed herein will be appreciated as the same becomes better understood by reference to the following detailed description, when considered in connection with the accompanying drawings.

FIG. 1 is a prior art diagram illustrating a relationship between battery positive and negative polarization as a function of a logarithm of applied charging current;

FIG. 2 is the diagram of FIG. 1, with further identified parameters and features;

FIG. 3 is a diagram illustrating a relationship between battery positive and negative polarization as a function of the logarithm of applied charging current, wherein the negative electrode voltage is combined with the positive electrode voltage;

FIG. 4 is a diagram illustrating a relationship between battery positive and negative polarization as a function of logarithm of applied charging current, wherein positive and negative electrode voltages are combined to provide a total battery voltage;

FIG. 5 is the diagram of FIG. 4 illustrating the total battery voltage as a function of the logarithm of applied charging current;

FIG. 6 illustrates the diagram of FIG. 5 and an example method of measuring the slope of the total battery voltage during the battery charging operation;

FIG. 7 illustrates the diagram of FIG. 6 wherein the measured slopes are used to provide a relationship showing a battery trend line (changing in slope of total battery voltage) as a function of the logarithm of applied charging current;

FIG. 8 is the diagram of FIG. 7 illustrating removal of the total battery voltage lines;

FIG. 9 is the diagram of FIG. 8 wherein the total battery voltages have been removed and illustrating the relationship between the battery trend line versus the logarithm of applied charging current;

FIG. 10 is a diagram illustrating the relationship between the battery trend line versus the logarithm of applied charging current, and denoting points therealong where the positive and negative electrodes have been fully charged;

FIG. 11 is the diagram of FIG. 10 illustrating an example method of charging a battery using trend line analysis, and denoting a charging operation termination point;

FIG. 12 is a diagram illustrating an actual charge profile for the charging algorithm as disclosed herein;

FIG. 13 is the diagram of FIG. 12 illustrating positive voltage and total battery voltage slopes;

FIG. 14 is the diagram of FIG. 12 illustrating a charge termination point;

FIG. 15 is a graph comparing actual life cycle performance for batteries charged in accordance with the algorithm as disclosed herein as compared with a traditional battery charging algorithm; and

FIG. 16 is a graph comparing actual weight loss per cycle for batteries charged in accordance with the algorithm as disclosed herein as compared with a traditional battery charging algorithm.

### DETAILED DESCRIPTION

A method for charging a battery as disclosed herein comprises the steps of determining a total battery voltage, i.e., the combined voltages of the positive and negative electrodes, during a charging operation where a charging current is being applied to the battery, and from the combined voltages evaluating the changes in the slope of the total battery voltage to provide a trend line (of the change in slope of the total battery voltage) as a function of the logarithm of the applied charging current. The method monitors the trend line using trend line analysis to detect a point during the charging operation, e.g., a change in the slope of the total battery voltage, that indicates both the positive and negative electrodes of the battery are at a full state of charge, and wherein at such point the charging operation can be terminated.

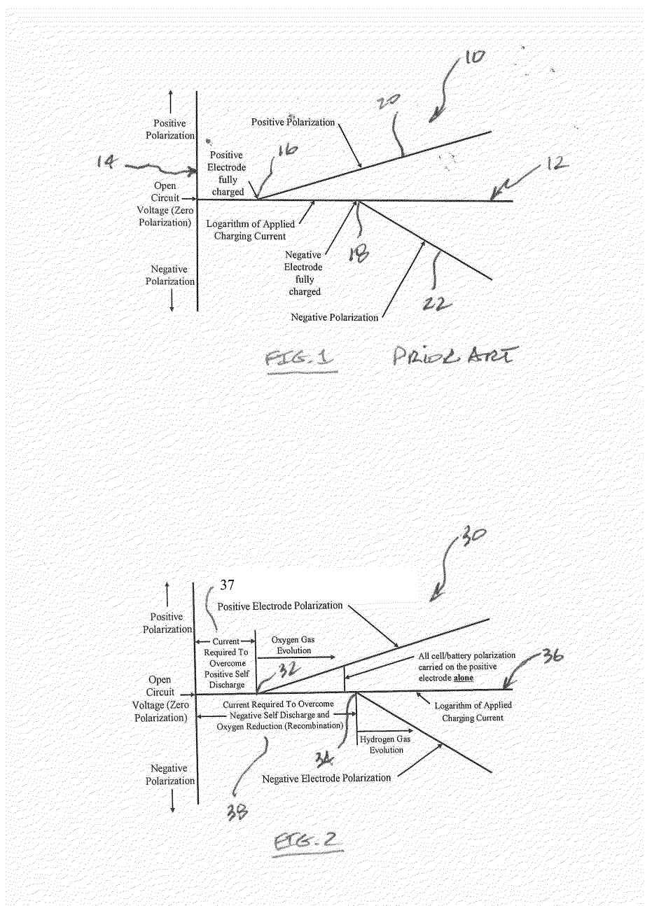

FIG. 1 illustrates a diagram 10 (Julius Tafel) graphically illustrating a relationship between the logarithm of applied charging current 12 (running along an x axis) versus the polarization of a battery's positive and negative electrodes 14 (running along a y axis) during a battery charging operation relative to an open circuit voltage (where the positive and negative electrodes each have zero polarization). As illustrated, as the charging process progress the positive electrode is the first to become fully charged at point 16, and then at a later point 18 in time during the charging process the negative electrode becomes fully charged. As illustrated, the slopes of the respective positive and negative polarization lines, 20 and 22 respectively, are essentially constant, although of different values.

FIG. 2 illustrates a diagram 30 similar to that of FIG. 1, wherein further observed parameters and features are provided. Specifically, it has been determined that the onset of gas production at the positive and negative electrodes, 32 and 34 respectively, is exactly coincident with the onset of polarization or the intercept of each electrodes polarization line with the zero polarization axis 36. Further, the location of the intercept of each electrodes polarization line with the zero polarization axis was determined to be a function of the extent of self-discharge occurring in each of the electrodes respectively, or the amount of current required to overcome such self-discharge in each of the electrodes, 37 and 38 respectively.

Conventional battery charging techniques involve applying a charging current to the battery, and doing so in a manner that focuses on the charging polarization of the battery positive electrodes alone such that the negative electrodes remain at zero polarization and, therefore does not generate any hydrogen which would cause water loss and dry out. This practice, however, does not bring the negative electrode to a full state of charge, resulting in its gradual loss of capacity over time due to local action of self-discharge, thereby limiting the effective service life of the battery.

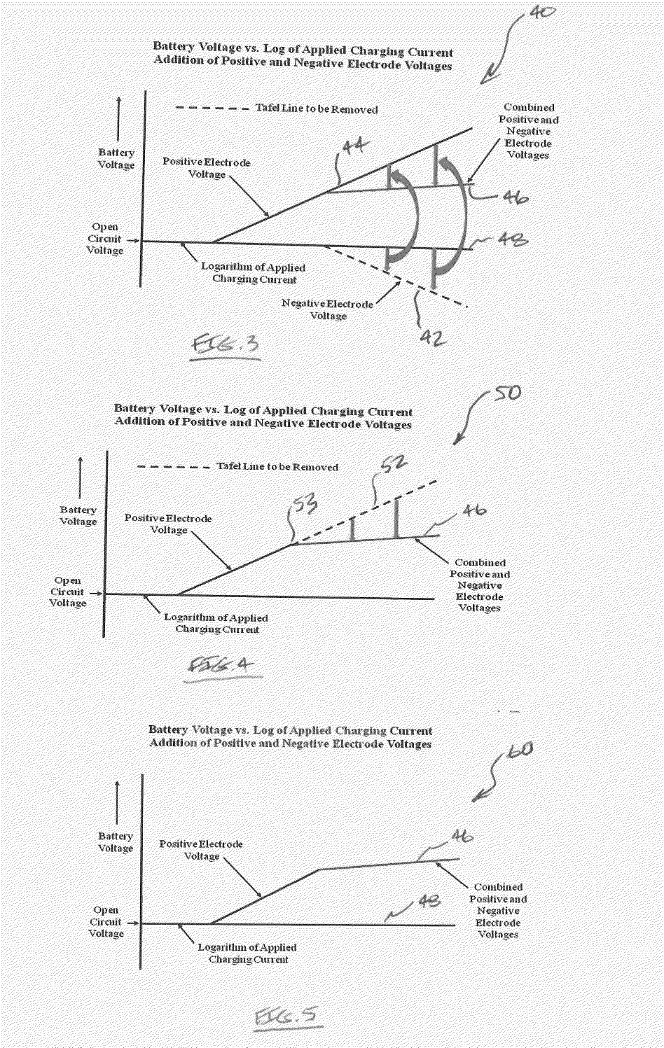

FIG. 3 illustrates a diagram 40, graphically showing a relationship between the logarithm of applied charging current versus positive and negative electrode voltage similar to that illustrated in FIG. 1. However, here the negative electrode voltage or polarization line 42 has been added to that of the existing positive electrode voltage or polarization line 44 to provide a total battery voltage line 46, thereby permitting monitoring of the total battery voltage 46 as a function of the logarithm of applied charging current 48. So here, the negative values of the negative electrode's Tafel line is added to that of the positive Tafel line to yield the overall battery voltage line versus the logarithm of the applied charging current.

FIG. 4 illustrates a further embodiment 50 the diagram of FIG. 3, showing the total battery voltage line 46 after the preexisting negative electrode voltage line has been remove and before a portion of the positive electrode voltage line 52 extending beyond the point 53 where the negative voltage (42 in FIG. 3) has been added thereto.

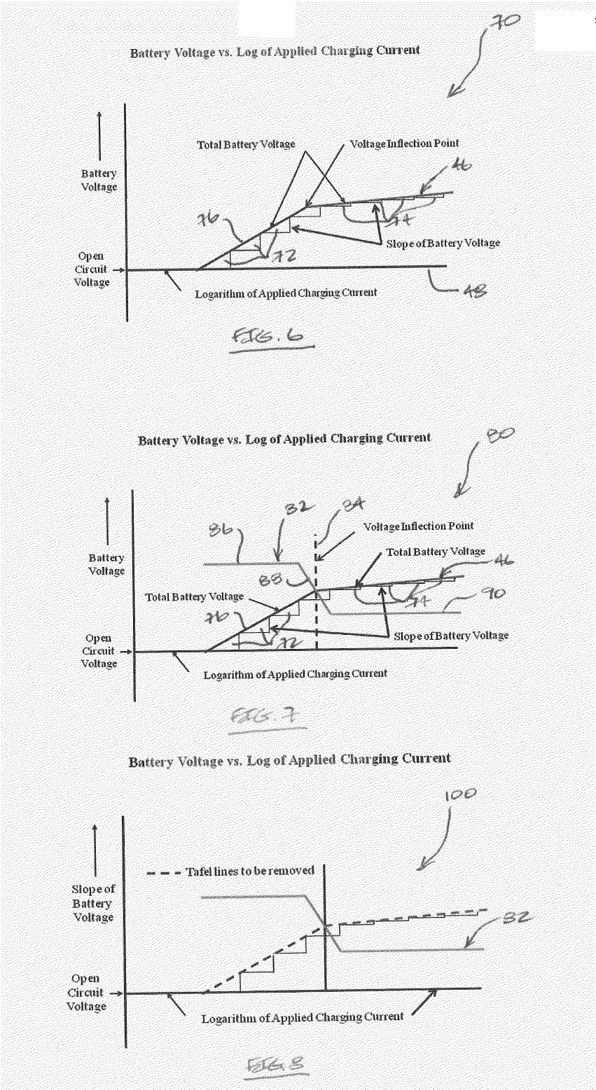

FIG. 5 illustrates a still further embodiment 60 of the diagram of FIG. 3, showing only the total battery voltage line 46 (resulting from combining the positive and negative voltages) as a function of the logarithm of the applied charging current 48. Thus, battery charging methods as disclosed herein include determining a total battery voltage as a function of the logarithm of the applied charging current during the process of charging a battery as disclosed above.

FIG. 6 illustrates a further embodiment 70 of the relationship of the total battery voltage line 46 as a function of the logarithm of applied charging current 48, wherein the charge current is incrementally increased. In an example battery charging method, the charging current is incrementally increased in a predetermined amount or increment for the purpose of measuring the slopes, 72 and 74 of the positive voltage line 76 and the combined positive and negative electrode voltage line 46. In such embodiment, an example switch point can be a point when the fully-charged state of the positive electrode is detected, which corresponds to the start of the total battery voltage line. In another example, the battery charging method may apply an incrementally increasing charging current to the battery throughout the battery charging operation.

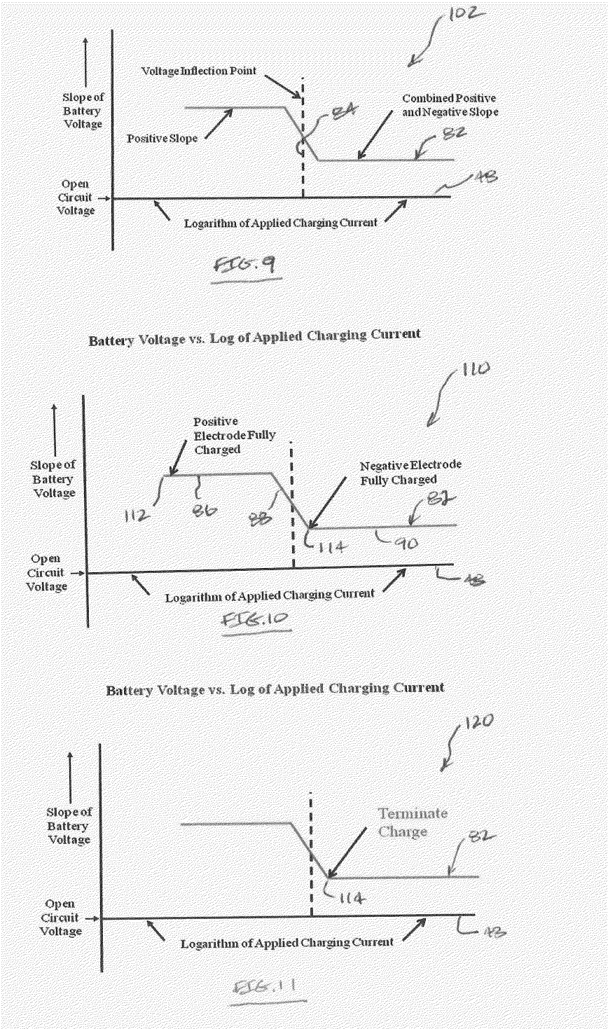

FIG. 7 illustrates a diagram 80 wherein the measured slopes 72 and 74 of the positive voltage 76 and the total or combined positive and negative voltage 46 have been used to determine a trend line 82 reflecting the change in slope for the total battery voltage line 46 as a function of the logarithm of the applied charging current 48, wherein such trend line 82 thereby illustrates the change in slope of total battery voltage during the battery charging operation. Accordingly, the battery charging method as disclosed herein includes the step of determining such trend line (change in slope of total battery voltage) as a function of the total battery voltage during the battery charging operation. In the example disclosed herein, such trend line is developed by measuring the slopes of the total battery voltage while an applied charging current is being incrementally increased.

As illustrated in FIG. 7, a voltage inflection point 84 is associated with the point along the total battery voltage line 46 were the negative electrode voltage or potential is increased and has reached a state of being fully charged, which event is denoted by a change in the slope of the total battery voltage line 46. The inflection point 84 can thus be determined/detected by monitoring the battery total voltage line 46 (which includes the initial section that is the positive voltage 76 and the following section which includes the combined positive and negative electrode voltage).

In an example embodiment, and as illustrated in FIG. 7, the trend line 82 comprises three distinct sections during a battery charging operation as disclosed herein: namely; a first section 86 that begins near the start of the battery charging operation when the positive electrode voltage or potential increases from zero polarization, and which is straight reflecting a constant slope for the positive electrode voltage from an initial stage of battery charging; a second section 88 that reflects a change in the slope of the total battery voltage line 46 as a result of the negative electrode voltage or potential increasing from zero polarization and being added to the positive electrode voltage, wherein the second section is sloped in a downward angle moving from the left to the right in FIG. 7; and a third section 90 that begins after the second section 88 at or near the end of the battery charging operation when the negative electrode voltage or potential increases from zero polarization, and which is straight reflecting a constant slope for the added positive and negative electrode voltages.

As illustrated in FIG. 7, the inflection point 84 is shown to extend from the total battery voltage line 46 upward to the trend line 82 and corresponding in position along the trend line to the second section 88 that is between the first and second sections 86 and 90, and more specifically adjacent a midpoint location along the second section 88. Accordingly, in an example battery charging method, the inflection point can be determined by monitoring the trend line for identifying the second section 88, and more specifically an approximate midpoint of the second section.

FIGS. 8 and 9 illustrate diagrams 100 and 102 similar to that of FIG. 7. Specifically, FIG. 8 illustrates a diagram showing the total battery voltage line and the measured slopes of the same to be removed, to thereby leave remaining the trend line 82. FIG. 9 illustrates a diagram showing the trend line 82 as a function of the logarithm of the applied charge current 48, and additionally showing the inflection point 84 from FIG. 7.

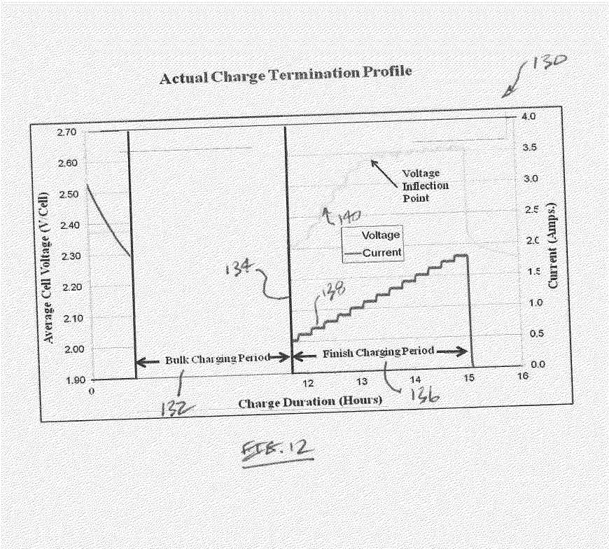

FIG. 10 illustrates a diagram 110 showing the trend line 82 as a function of the logarithm of the applied charging current 48, as developed in accordance with the battery charging method disclosed herein. The trend line 82, derived in the manner disclosed, is useful for monitoring and denoting the state of the battery during a charging operation. The start 112 of the trend line 82, i.e., where the trend line first section 86 begins, indicates the point in the charging operation where the positive electrodes are fully charged. The point 114 along the trend line defines the end of the second section 88 and the beginning of the third section 90 and indicates the point in the charging operation where the negative electrodes are fully charged.

As noted above, conventional battery charging approaches do not provide an optimal technique for charging batteries because they focus on charging only the positive electrodes and, thus the negative electrodes generally do not achieve a full state of charge that causes the battery to gradually loose capacity over time due to local action, which prematurely reduces the effective service life of the battery.

FIG. 11 illustrates a diagram 120 showing the relationship of the trend line 82 as derived herein versus the logarithm of the applied charging current 48 for the purpose of using the same for charging a battery according to the methods disclosed herein. As noted above, the point during the charging operation where the negative electrodes become fully charged is easily denoted by monitoring the trend line 82 to determine the point 114 (where the trend line second section terminates and the trend line third section begins) therealong. Once this point 114 is reached, or soon thereafter, the charging operation can be terminated. In an example embodiment, the charging operation is terminated upon detecting point 114 on the trend line so as to assure that a full charge is achieved while further over charge (an subsequent water loss) is not experienced. It is to be understood that the exact point of terminating the battery charging operation can and will depend on such factors as the particular battery type and/or size, as well as the battery end-use application.

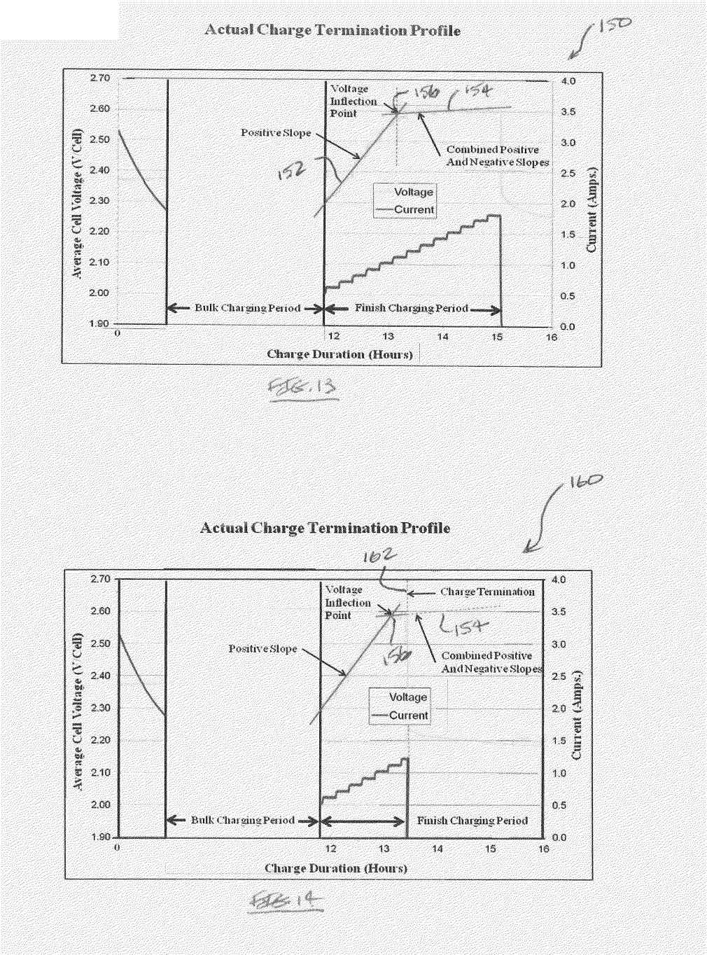

FIG. 12 illustrates a battery charge profile 130 implementing the battery charging algorithm and methods as disclosed herein. Specifically, the charge profile comprises a bulk charging period 132 that takes place for a period of time from the start of the battery charging process. During the bulk charging period the charging current is monitored and tapers down to a value where it ceases to decline further and becomes essentially constant at what is termed the finish rate. The finish rate takes place at approximately point 134 of the charge profile.

A charge controller or the like (e.g., a control computer) detects that the charge current has stopped decreasing during the bulk charging period, and proceeds to the first phase of implementing the charging algorithm as disclosed herein, which takes place during a finishing charging period 136. In this first phase, as illustrated in FIG. 12 the charge current 138 is gradually stepped up in small increments from the finishing rate current value and the on change voltage resulting from the voltage resulting from the changed charge current is measured and recorded by the charge controller. In an example, the on charge voltage 140 reflects the same incremental steps as observed in the current profile.

FIG. 13 illustrates the battery charge profile 150 during a second phase of the process where the charge controller applies appropriate mathematical methods to filter and smooth the steps out of the on charge voltage data such that a straight slope line is developed, and the slope for all points on the curve is determined. Specifically, the charge controller determines a straight slope line 152 for the positive electrode voltage, and a straight slope line 154 for the combined positive and negative electrode voltages (or the overall battery voltage). The slope lines 152 and 154 and their intersection 156 as taken from actual data are essentially identical to that predicted from the discussion and treatment disclosed and illustrated above of the Tafel curves.

During a next phase of the process the charge controller looks for a change in the slope of the battery voltage, e.g., where the slope 152 of the positive electrode voltage changes. The point at which the change of slope occurs is designated the voltage inflection point 156, and is recognized as the point in the charge process when the negative electrode is approaching a full state of charge.

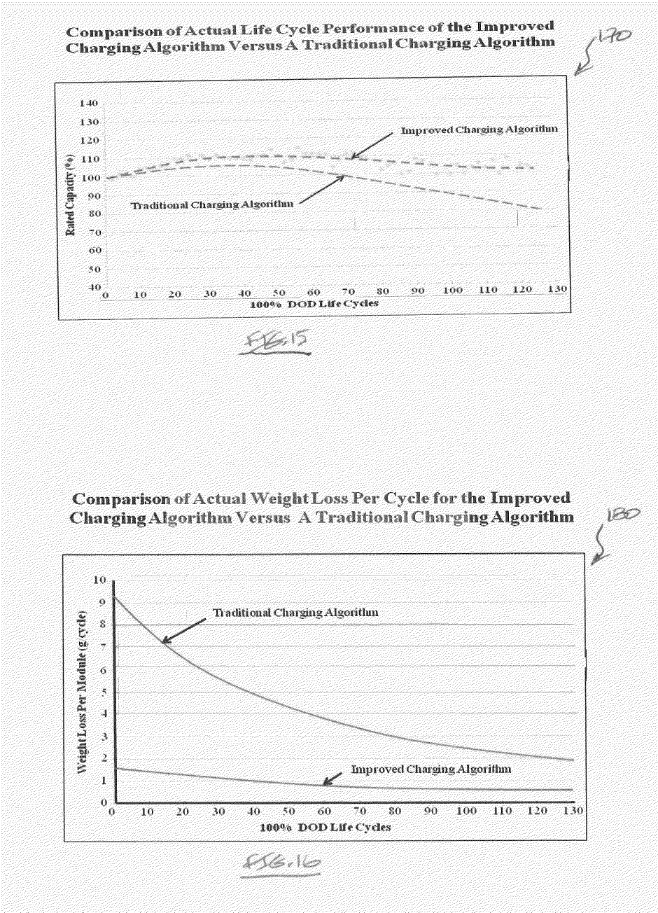

FIG. 14 illustrates the battery charge profile 160 during a further phase of the process after the voltage inflection point 156 has been determined. During this further phase, the charge controller watches the slope line 154 of the combined positive and negative electrode voltage until it becomes constant or straight, which indicates that both the positive and negative electrodes are in a fully charged state. At this point, having verified that both the positive and negative electrodes have completed their charge cycles and are fully charged, the charge controller terminates the charge 162 and cuts off power to the battery

An advantage of the battery charging method as disclosed herein using trend line analysis/monitoring is that the complete charge of the negative electrodes is assured without subjecting the negative electrodes to undesirable excess overcharge. Further, the advantages of the method as disclosed herein and the technique of charge termination are that a reference electrode is not required and it automatically compensates for fluctuations in battery voltage due to temperature and age (e.g., wetness or dryness of the cells). This is so because the polarization profile curve is based only on the value of the polarization and is thereby dimensionless (e.g., not dependent based on the absolute values of either current or voltage).

FIG. 15 is a graph 170 comparing the actual life cycle performance of batteries charged using the improved charging algorithm and method as disclosed herein as contrasted with those charged using a traditional battery charging algorithm. Specifically, the upper line 172 illustrates the life cycle of batteries charged using the improved charging algorithm, while the lower line 174 illustrates the life cycle of batteries charged using a traditional battery charging algorithm. As illustrated, batteries charged using the improved charging algorithm display an increased or higher capacity over more life cycles than batteries charge using the traditional charging algorithm. Undercharging a valve regulated lead-acid battery allows the negative electrode's capacity to gradually walk down and loose capacity due to self-discharge. Overcharging a valve regulated lead-acid battery causes the negative electrodes to make hydrogen gas, thus consuming water and diminishing the battery capacity as a whole due to dry out. By charging the battery exactly to the point of full charge (as accomplished using the improved charging algorithm and methods as disclosed herein) avoids the pitfalls of undercharging and overcharging commonly observed with conventional battery charge algorithms, thus enabling the battery capacity to be maintained at a higher level over more life cycles as compared to batteries charged using conventional charging algorithms.

FIG. 16 is a graph 180 that compares an actual weight loss per cycle for batteries charged using the improved algorithm and methods as disclosed herein to those charged using a traditional charging algorithm. Line 182 designates the weight loss observed for batteries charged by traditional algorithm, while line 184 designates the weight loss observed for batteries charged using the improved algorithm and methods as disclosed herein. As illustrated, the weight loss per cycle for batteries charged using the improved algorithm as disclosed herein display a dramatic decrease in weight loss (or a reduced dry out) relative to the weight loss for batteries charged by traditional algorithm. The impact of dry out due to water loss caused by overcharge of the negative electrodes with traditional charge algorithms is significant.

In an example embodiment, the battery charging method as disclosed herein, can be implemented by a device capable of delivering a desired charging current to a battery. The device can be configured to provide a constant increasing charging current as well as an intermittent increasing charging current. The device can be configured comprising a power supply and a charge controller in the form of a microprocessor or the like capable of being programed in a manner so as once the device is connected to a battery for charging, it is able to determine the total battery voltage in the manner described above, it is able to measure the slope of the total battery voltage in the manner described above, and from this information is it able to develop and monitor the battery trend line for the purpose of determining the point where the negative electrodes have achieved a full state of charge for terminating the charging operation.

In an example embodiment, such device is provided in the form of a unitary construction to enable easy operation by a user. In such example embodiment, the device comprises a power supply, cables and connectors for attaching to the battery positive and negative electrodes, and comprises a user interface for operating the battery charging device and implementing the battery charging operation. In an example embodiment, the device may comprise a simple on/off switch, and may be configured to automatically turn off once the point of the negative electrodes being fully charged is detected.

Methods for charging batteries as disclosed herein can be used with many different types of rechargeable batteries including but not limited nickel-cadmium, nickel metal hydride, nickel-iron, lithium, silver-cadmium, flooded electrolyte batteries, deep-cycle lead acid batteries, or the like. Methods as disclosed herein are especially well suited for charging lead acid batteries that may or may not be valve regulated, and that are designed or constructed to withstand repeated cycles of substantial discharge and recharge.

While the methods and devices for implanting the same have described above with reference to particular examples and illustrations, it will be understood that variations on the steps of the methods and/or in the features of the devices, are understood to exist and be within the scope of the methods and devices as disclosed herein. Thus, the foregoing description of preferred and other embodiments and forms of the methods and/or devices have been presented by way of example, not as a catalog of all forms which can exist. Those skilled in the relevant art will understand that variations and modifications of the described methods and devices can be used beneficially without departing from this disclosure.

What is claimed is:

1. A method for charging a rechargeable battery comprising a positive and negative electrode, the method comprising the steps of:
applying a charging current to the battery;
monitoring the voltages of the positive and negative electrodes during the step of applying;
determining a point where the negative electrode is fully charged during the step of applying; and
terminating the charging current at some point after the negative electrode is fully charged.

2. The method as recited in claim 1 wherein the step of monitoring comprises determining the total battery voltage from the combined voltages of the positive and negative electrodes.

3. The method as recited in claim 1 wherein the step of monitoring comprises adding the negative voltage to the positive voltage to obtain a total battery voltage, and measuring the slopes along the total battery voltage to obtain a trend line of the change in the slope of the total battery voltage.

4. The method as recited in claim 3 wherein the trend line is monitored against a logarithm of the applied charging current.

5. The method as recited in claim 3 wherein the point where the negative electrode is fully charged is a point on the trend line where a slope of the trend line goes from being angled to being straight.

6. The method as recited in claim 3 wherein the trend line comprises:
a first straight section that relates to a constant slope of the positive electrode voltage when it is in a state of charge;
a second angled section extending from the first section that relates to a change in slope between the positive electrode voltage when it is in a state of being charged and the combined positive and negative voltages when each are in a state of being charged; and
a third straight section that relates to a constant slope of the combined positive and negative electrode voltages when each is in a state of charge.

7. The method as recited in claim 6 wherein the point where the negative electrode is fully charged occurs at the intersection of the trend line second and third sections.

8. The method as recited in claim 1 wherein the battery is a flooded electrolyte battery.

9. The method as recited in claim 8 wherein the battery is a lead-acid battery.

10. The method as recited in claim 1 wherein during the step of determining, at the point that the negative electrode is fully charged, the positive electrode is also fully charged.

11. The method as recited in claim 1 wherein the step of terminating is conducted a desired time after the point where the negative electrode has been determined to be fully charged.

12. The method as recited in claim 1 wherein during the step of monitoring, a slope line for the positive electrode is determined, and a slope line for the combined positive and negative electrodes are determined.

13. The method as recited in claim 12 wherein the step of determining comprises monitoring the slope line for the combined positive and negative electrodes until the slope line for the combined positive and negative electrodes is constant.

14. A method for charging a lead-acid battery comprising one or more positive and negative electrodes, the method comprising the steps of:
applying a charging current to the battery;
combining the voltages of the positive and negative electrodes to determine a total battery voltage;
monitoring a slope of the total battery voltage as a function of a logarithm of the applied charging current; and
terminating the application of the charging current after the slope of the total battery voltage as a function of logarithm of the applied charging current has been found to change indicating that the negative electrode is fully charged.

15. The method as recited in claim 14 wherein the slope of the total battery voltage is a total battery trend line, and wherein the trend line is determined by measuring the differences in the slope of the total battery voltage.

16. The method as recited in claim 15 wherein the trend line comprises:
a first straight section that relates to a constant slope of the positive electrode voltage when it is in a state of charge;
a second angled section extending from the first section that relates to a change in slope between the positive electrode voltage when it is in a state of being charged and the combined positive and negative electrode voltages when each are in a state of being charged; and
a third straight section that relates to a constant slope of the combined positive and negative electrode voltages when each is in a state of charge.

17. The method as recited in claim 16 wherein the negative electrode is fully charged at an intersection between the second and third sections.

18. The method as recited in claim 14 wherein the negative electrode is fully charged at an inflection point of the slope of the total battery voltage.

19. The method as recited in claim 14 wherein the positive electrode is in a state of full charge at the point when negative electrode is fully charged.

20. The method as recited in claim 14 wherein the step of terminating occurs less than about 5 minutes after the negative electrode is fully charged.

21. A device for charging a flooded lead acid battery comprising a positive and a negative electrode, the device comprising:
means for generating a charging current from an available AC power source for applying the charging current to the battery;
means for adding the voltages of the positive and negative electrodes to develop a total battery voltage as the battery is being charged;
means for monitoring the change in slope of the total battery voltage as a function of the logarithm of the applied charging current to develop a battery trend line; and
means for terminating the charging current applied to the battery when the trend line indicates that the negative electrode has been fully charged.

22. The device as recited in claim 21 wherein the means for adding comprises a microprocessor.

23. The device as recited in claim 21 wherein the means for monitoring comprises a microprocessor.

24. The device as recited in claim 21 wherein the means for terminating comprises a controller that is operated by a microprocessor.
